(19) United States
(12) Patent Application Publication
(10) Pub. No.: US 2010/0150208 A1
(43) Pub. Date: Jun. 17, 2010

(54) METHOD AND APPARATUS FOR CONSERVING TRANSCEIVER POWER

(75) Inventors: Kulvir Singh Bhogal, Pflugerville, TX (US); Lisa Seacat DeLuca, San Francisisco, CA (US); Robert Ross Peterson, Austin, TX (US); Mark Wllliam Talbot, Austin, TX (US)

Correspondence Address: Snell & Wilmer L.L.P. (IBM Corp), 600 Anton Blvd, Suite 1400, Costa Mesa, CA, 92626, US

(73) Assignee: International Business Machines Corporation, Armonk, NY (US)

(21) Appl. No.: 12/336,285

(22) Filed: Dec. 16, 2008

(51) Int. Cl. H04B 1/713

(52) U.S. Cl. 375/133; 375/E01.033

(57) ABSTRACT

The present invention utilizes radio-frequency identification (“RFID”), which consume a small amount of energy, to allow two transceivers with frequency hopping spread spectrum units to discover each other. A first transceiver may, for example, have a first energy capacity, an RFID transceiver, and a first frequency hopping spread spectrum unit. A second transceiver with a lower energy capacity would then have an active RFID tag and a second frequency hopping spread spectrum unit.

### BACKGROUND

1. Field of the Invention

The present invention relates to a method and apparatus for conserving transceiver battery life when using a frequency hopping spread spectrum unit to communicate with a second transceiver.

2. Description of Related Art

When a transceiver, such as a cell phone, using frequency hopping spread spectrums, for example, is constantly searching for a second transceiver the power consumption can rapidly drain the battery of the transceivers.

Thus, there is a need for a method and apparatus for conserving transceiver power.

### SUMMARY

The present invention conserves power by powering down the transceiver with the lower power capacity. The present invention utilizes radio-frequency identification (“RFID”), which consume a small amount of energy, to allow the two transceivers with frequency hopping spread spectrum units to discover each other. A first transceiver may, for example, have a first energy capacity, an RFID transceiver, and a first frequency hopping spread spectrum unit. A second transceiver with a lower energy capacity would then have an active RFID tag and a second frequency hopping spread spectrum unit. To conserve energy, the second frequency hopping spread spectrum unit in the second transceiver is disabled when not in use. The first transceiver containing the RFID transceiver searches for the active RFID tag of the second transceiver when the first transceiver receives an incoming signal, for example an incoming call, from an external device like a third transceiver. When the RFID transceiver discovers the active RFID tag in the second transceiver, the RFID transceiver sends an activation signal to the active RFID to wake up the second frequency hopping spread spectrum unit in the second transceiver. The first frequency hopping spread spectrum unit and the second frequency hopping spread spectrum unit are then paired together to communicate with the external device. Once communication with the external device is ended, the first frequency hopping spread spectrum unit turns off the second frequency hopping spread spectrum unit.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic diagram of transceivers in an embodiment of the present invention; and

FIG. 2 is a flow diagram for conserving power in a transceiver in an embodiment of the present invention.

### DETAILED DESCRIPTION

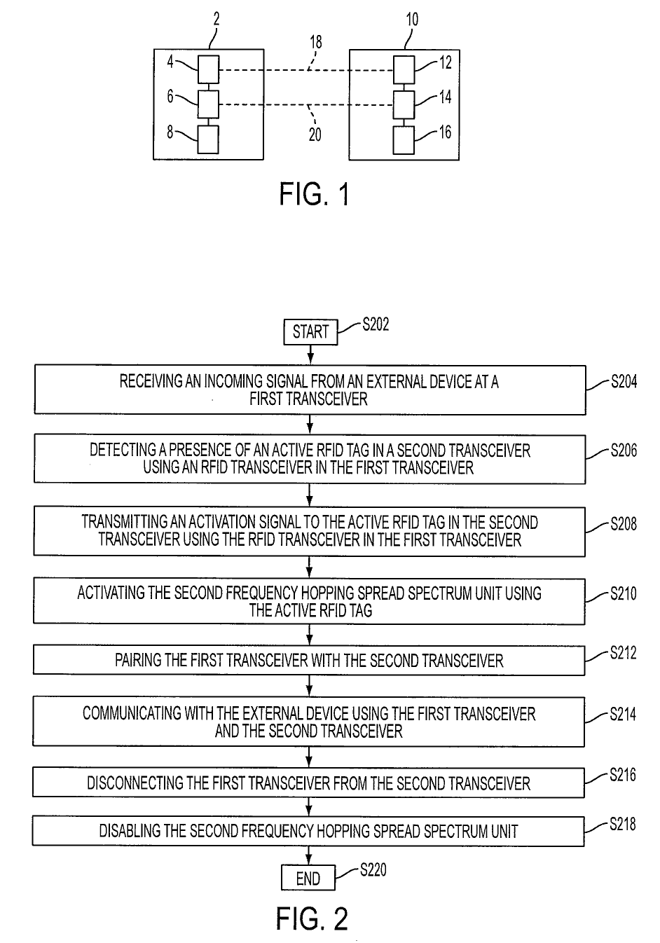

As seen in FIG. 1, the present invention utilizes transceivers such as transceiver 2 and transceiver 10. Transceiver 2 and transceiver 10 can be, for example, Bluetooth compliant devices. The Bluetooth standard is promulgated by the Bluetooth Special Interest Group. Transceiver 2 includes a radio-frequency identification (“RFID”) transceiver 4, a frequency hopping spread spectrum unit 6, and an energy storage unit 8. Transceiver 10 includes an active RFID tag 12, a frequency hopping spread spectrum unit 14, and an energy storage unit 16. RFID transceiver 4 is connected to frequency hopping spread spectrum unit 6 and frequency hopping spread spectrum unit 6 is connected to energy storage unit 8. Active RFID tag 12 is connected to frequency hopping spread spectrum unit 14, and frequency hopping spread spectrum unit 14 is connected to energy storage unit 8.

Energy storage unit 8 has a greater energy capacity than energy storage unit 16. In another embodiment, energy storage unit 16 can have an equal or greater energy capacity than energy storage unit 8. The energy capacity of energy storage unit 8 and energy storage unit 16 can also be determined, for example, by whether or not energy storage unit 8 and/or energy storage unit 16 are connected to an external power supply. Transceiver 2 can be, for example, a mobile phone, an automobile, automobile stereo, a computer, a headset, or any other electronic device. Transceiver 10 can be, for example, a mobile phone, an automobile, a computer, a headset, or any other electronic device.

RFID transceiver 4 can be, for example, an RFID reader. Transceiver 2 could also include any type of RFID tag in addition to RFID transceiver 4. Likewise although an active RFID tag is used, transceiver 10 could use instead a passive RFID tag, or a semi-passive RFID tag. Transceiver 10 could also include any type of RFID transceiver in addition to active RFID tag 12.

In one embodiment, the process disclosed in FIG. 2 can be performed to conserve power in transceiver 10. In Step S202, the process begins. In Step S204, transceiver 2 receives an incoming call signal from an external device (not shown). In Step S206, transceiver 2 uses RFID transceiver 4 to detect a presence of active RFID tag 12 in transceiver 10. Frequency hopping spread spectrum unit 14 in transceiver 10 can be in a disabled state. In Step S208, when the presence of active RFID tag 12 is detected by RFID transceiver 4, RFID transceiver 4 transmits an activation signal to active RFID tag 12, for example through connection 18. The activation signal can indicate that active RFID tag 12 should activate frequency hopping spread spectrum unit 14.

In Step S210, when active RFID tag 12 receives the activation signal from RFID transceiver 4, active RFID tag 12 activates frequency hopping spread spectrum unit 14. In Step S212, transceiver 2 and transceiver 10 are then paired together using frequency hopping spread spectrum unit 6 and frequency hopping spread spectrum unit 14 through connection 20. In Step S214, a user can communicate with the external device using transceiver 2 and transceiver 10.

In Step S216, after the user has finished communicating with the external device, transceiver 2 and transceiver 10 are disconnected from each other. In Step S218, frequency hopping spread spectrum unit 14 is disabled to conserve power in transceiver 10. This can be done for example, by having RFID transceiver 4 send a signal to active RFID tag 12, or it can be done automatically by transceiver 10 upon a pre-determined criteria such as the disconnection between transceiver 10 and transceiver 2 or the termination of communication with the external device.

By disabling frequency hopping spread spectrum unit 14, a power consumption of frequency hopping spread spectrum unit 14 will be reduced or eliminated. Since active RFID tag 12 can use comparatively less power than frequency hopping spread spectrum unit 14, an overall amount of power used by transceiver 10 can be reduced thus prolonging an amount of time that the user has before requiring to re-charge transceiver 10. In one embodiment, active RFID tag 12 could also receive some power from the waves emitted by RFID transceiver 4, which could further reduce a power consumption of active RFID tag 12 on energy storage unit 16 and thus prolong an amount of time that the user has before requiring to re-charge transceiver 10.

RFID tag 12 can comprise conventional RFID tags adapted to emit periodic identification or beacon signals. In one embodiment, RFID tag 12 is configured to activate an auxiliary system in response to a signal from a remote source. In still another embodiment, RF ID tag 12 is configured to provide an identification signal to RFID receiver 2 confirming its identity. Once identity of device 10 is confirmed, device 2 can take steps to remotely activate device 10. Remote activation can occur through the RF system or through physical connection.

In another embodiment of the invention, device 2 can communicate with a plurality of RFID tags (not shown) in the same vicinity. Once an external signal is received by device 2, it may survey available RFID tags to identify the appropriate device from among the plurality of devices equipped with ID tags. The appropriate device can then be activated as discussed above.

In another embodiment, although RFID transceiver 4 is connected to energy storage unit 8, which may have a larger energy capacity than energy storage unit 16, RFID transceiver 4 could be constructed to utilize less energy than frequency hopping spread spectrum unit 6. This could also reduce an amount of power used by transceiver 2.

In yet another embodiment, RFID transceiver 4 can send an activation signal to active RFID tag 12 when RFID transceiver 4 detects a presence of active RFID tag 12. This can be done without transceiver 2 having received an incoming call signal. Furthermore, frequency hopping spread spectrum unit 14 can remain active so long as transceiver 2 and transceiver 10 are within a predetermined range of each other. When they are within a predetermined rang of each other, transceiver 2 can be paired with transceiver 10 using frequency hopping spread spectrum unit 6 and frequency hopping spread spectrum unit 14. Once transceiver 2 and transceiver 10 exceed the predetermined range, transceiver 2 and transceiver 10 can be disconnected from each other. Once they are disconnected from each other, transceiver 10 can disable frequency hopping spread spectrum unit 14. Frequency hopping spread spectrum unit 14 can be activated again when RFID transceiver 4 detects the presence of active RFID tag 12.

The present invention can also encompass a system using a first low power unit in a first device and a second low power unit in a second device to activate a high power unit in the second device. This could conserve energy within the second device. The steps disclosed in FIG. 2 can be performed by a computer and can also be embodied on a computer-readable medium which causes a computer to perform certain functions. Furthermore, the steps can also be executed by a processor.

While the specification has been disclosed in relation to the exemplary and non-limiting embodiments provided herein, it is noted that the inventive principles are not limited to these embodiments and include other permutations and deviations without departing from the spirit of the disclosure.

1. A method for conserving power in a system having at least a pair of communicating transceivers in communication with an electronic device, the method comprising the steps of:
receiving an incoming signal from the electronic device at a first transceiver having a first frequency hopping spread spectrum unit and a radio-frequency identification (“RFID”) transceiver;
the RFID transceiver in the first transceiver searching for an active RFID tag in a second transceiver;
the RFID transceiver in the first transceiver activating the active RFID tag in the second transceiver to activate the second frequency hopping spread spectrum unit in the second transceiver;
the first frequency hopping spread spectrum unit pairing with the second frequency hopping spread spectrum unit, to allow the first transceiver and the second transceiver to communicate with the electronic device; and
disabling the second frequency hopping spread spectrum unit in the second transceiver when communication with the electronic device is ended.
